(19) United States
(12) Patent Application Publication
(10) Pub. No.: US 2016/0368719 A1
(43) Pub. Date: Dec. 22, 2016

(54) EMPTYING DEVICE

(71) Applicant: HECHT TECHNOLOGIE GMBH, Pfaffenhofen/Ilm (DE)

(72) Inventor: Gunther HECHT, Pfaffenhofen/Ilm (DE)

(73) Assignee: HECHT Technologie GmbH, Pfaffenhofen/Ilm (DE)

(21) Appl. No.: 15/111,088

(22) PCT Filed: Jan. 13, 2015
(86) PCT No.: PCT/EP2015/050507

§ 371 Date: Jul. 12, 2016

(30) Foreign Application Priority Data
Jan. 13, 2014 (DE) 10 2014 200 452.7

(51) Int. Cl. B65G 65/36; B65G 69/18; B65G 53/42

(52) U.S. Cl. CPC B65G 65/36; B65G 53/42; B65G 69/181

(57) ABSTRACT

An emptying device for emptying a container, in particular a barrel, containing a product. The emptying device including an insulation device, which defines an internal space and allows operations of a user in the internal space without a risk of contamination for the user; a container connection device for connecting the container to the insulation device such that there is no risk of contamination for the user by means of the product; and a conveyor pipe line arranged in the internal space, wherein the conveyor pipe line has a connector end which is attached to a pipe connection arranged in the internal space for guiding the product out of the insulation device and which can be moved for emptying the container such that a conveyor end of the conveyor pipe line is located in the container if the container is connected.

The invention relates to an emptying device for emptying a container, in particular a barrel, containing a product.

According to the prior art, containers, in particular barrels, are emptied by means of devices in which suction lances are fed through a plate arranged on the barrel or through an insulator arranged on the barrel. A pneumatic conveyor device which sucks off the product present in the barrel is connected to the corresponding suction lance.

The suction lances used here have a specific length, depending on the height of the barrels to be emptied, and are made from a metal, for which reason the suction lances can be moved and handled by a user during the emptying of the barrel only with a required force which is not negligible.

Against this background, the object of the invention is to provide an emptying device for emptying a container, in particular a barrel, containing the product, which allows for more easily or at least an alternative way of emptying of a container containing a product.

This object is achieved by an emptying device according to claim 1. Further preferred embodiments are subject of the depending claims.

The emptying device according to the present invention is in particular used for emptying containers which contain a powdery and/or granular product, which, for example, poses a potential risk to a user, potentially contaminates the environment and/or has a purity level which is to be maintained.

According to the invention, an emptying device for emptying a container, in particular a barrel, containing a product comprises an insulation device which defines an internal space or has such an internal space and allows a user to perform operations inside the internal space without a risk of contamination for the user.

Such an insulation device may be, for example, an insulator having glove ports at which gloves are sealingly attached by means of which the user can perform operations in the internal space of the insulator. As a result of the insulator having sealingly attached gloves for the user, the user does not directly come into contact with the internal space of the insulator and thus, the user does not directly come into contact with a product present in the internal space. Thereby it is ensured that there is no risk of contamination for the user.

Furthermore, the emptying device according to the invention comprises a container connection device for connecting the container to the insulation device such that there is no risk of contamination for the user by means of the product.

Such a container connection device may be, for example, a ring provided at an opening leading into the insulation device and having recesses formed thereon and/or an inflatable seal provided thereon. The recesses and/or the inflatable seal serve for attaching a foil bag enclosing the product in the container to be emptied or, if the product is enclosed by a plurality of foil bags due to safety reasons, for attaching each foil bag of the plurality of foil bags.

The container connection device is preferably arranged at a bottom side of the insulation device, wherein the container and a barrel, respectively, to be emptied can be brought close to the container connection device by lifting, for example.

For example, in case of a barrel in which the product is enclosed by two foil bags due to safety reasons, the outer foil bag is attached at the outer surface of the ring, which is provided at the opening, at an inner recess of two recesses by means of an O-ring such that a foil remnant which is attached at an outer one of the two recesses and originates from a previous emptying operation is sealed. Subsequently, the foil remnant is removed via the insulation device, which allows operations of the user in its internal space without the risk of contamination for the user, from the outer recess through the internal space of the insulation device. After removing the foil remnant, the second inner foil bag, which is hitherto still closed and encloses the product in the barrel, is accessible via the insulation device and can be opened by means of the sealingly attached gloves. Henceforth, the opened inner foil bag can be put over a clamping ring, for example, and attached and fixed, respectively, at the opening by means of expansion of the inflatable seal.

After this, the product to be taken out of the barrel is accessible through the internal space of the insulation device, wherein, as explained above, the connecting of the container did not lead to a risk of contamination for the user by the product.

Depending on which kind of container is to be connected to the insulation device, the container connection device may be configured accordingly. For example, the emptying device may be configured such that the container connection device is replaceable, in particular for the adaptation to different diameters of the barrels.

In particular, the container connection device is configured for connecting a barrel, which includes one or two foil bags enclosing the product in the barrel, without contamination. Preferably, for connecting a barrel, the container connection device may comprise a seal which is provided at an outer surface of the insulation device and against which the barrel to be emptied and the upper edge thereof, respectively, can be pressed.

Furthermore, the emptying device according to the invention comprises a conveyor pipe line arranged in the internal space and having a connector end attached to a pipe connection arranged in the internal space for guiding the product out from the insulation device and which can be moved for emptying the container, in particular the barrel, such that a conveyor end of the conveyor pipe line is arranged in the container if the container is connected.

The pipe connection may be formed by a connection element which is welded in a side wall of the insulation device and which may project from the sidewall into the internal space. At the pipe connection, the conveyor pipe line is, for example, formed by a clamping connection, which connects a flange of the pipe connection with a flange of the conveyor pipe line via a clamp. At an outer surface of the insulation device, an external connection is provided which communicates with the pipe connection and at which preferably a pneumatic conveyor device is attached. The product can be guided through the pipe connection and the external connection out of the insulation device.

In particular, by the fact that no rigid and potentially very long and heavy suction pipe needs to be fed through an opening provided in the insulation device, but that according to the invention the conveyor pipe line extends from the stationary (immovable and firmly anchored, respectively) pipe connection, which is arranged in the internal space, and the conveyor end is movable into the container to be emptied, the conveyor pipe line and thus the emptying of the container can be more easily handled. In general terms, the moved parts are located in the internal space of the insulation device.

Taken as a whole, the emptying of the container is less strenuous. Preferably, the conveyor pipe line is formed by a flexible conveying hose and/or a telescopic suction pipe.

If the conveyor pipe line is exclusively formed of a flexible conveying hose, the user can easily move the conveying hose and the conveyor end thereof, respectively, into the container for emptying and taking out, respectively, the product.

In the other case, in which the conveyor pipe line is exclusively formed of the telescopic suction pipe, the user can extend the telescopic suction pipe so that the conveyor end of the telescopic suction pipe reaches the product located in the container to be emptied.

In order to ensure that the entire product located in the container can be taken out with the telescopic suction pipe, it is possible, for example, to configure the container connection device such that the container to be emptied—in a connected state—is movable perpendicularly to a longitudinal axis of the telescopic suction pipe. Preferably, this movement can be achieved by rotating the container such that a longitudinal axis of the container/barrel to be emptied rotates around the longitudinal axis of the telescopic suction pipe.

Furthermore, the conveyor pipe line may be formed of a combination of a flexible conveying hose and a suction pipe/telescopic suction pipe.

By using a flexible conveying hose, in particular a weight reduction of the conveyor pipe line is achieved.

Preferably, the conveyor end of the conveyor pipe line is formed by a suction pipe or a telescopic suction pipe, wherein the suction pipe or the telescopic suction pipe is attached to the pipe connection via a flexible conveying hose.

Thereby, the suction pipe or the telescopic suction pipe can be easily fed into the container containing the product and the product can be easily taken out.

Preferably, the conveyor pipe line is attached to a suspension in the internal space, wherein the suspension allows for the movement of the conveyor end in the container and supports the conveyor pipe line during the movement.

Hereby, the user performing the operation—namely the moving of the conveyor pipe line—in the internal space by means of the sealingly attached gloves, for example, is supported, for which reason the emptying of the container and the taking out of the product, respectively, is facilitated.

Preferably, the suspension comprises a guard rail and a slide which is displaceable on the guard rail, wherein the conveyor pipe line is attached to the slide such that the conveyor end is moved either into or out of the container by displacing the slide.

In this connection, it is in particular preferred that the guard rail is linear, ergo the suspension is a linear guide. Alternatively, the guard rail may have a curved shape such that the conveyor end moves in a curved manner when the slide is displaced.

Depending on the sizes of the containers/barrels to be emptied, the conveyor pipe line may be moved/displaced for moving the conveyor end into/out of the container by means of a drive unit such as a motor. Here, the drive unit may, for example, support a manual operation of the user or the drive unit may also completely take over the moving of the conveyor pipe line.

If the suspension is provided in the form of the guard rail and the slide, a drive unit, for example a motor, may in particular be mounted at the slide, wherein the drive unit/the motor can be operated for displacing the slide. The drive unit/the motor may in particular be configured such that it has a FDA-certification (food and drug administration) and an EX-certification (explosion protection approval).

The drive unit(s)/the motor(s) mentioned above may be pneumatically driven or electrically driven motors, for example.

Preferably, the conveyor end is formed by a suction pipe which is attached to the pipe connection via a flexible conveying hose. The conveying hose has an end corresponding to the connector end, which is attached to the pipe connection, and an other end which is connected to the slide, wherein the suction pipe is attached to the slide and/or the conveying hose via a connection hose which is more flexible than the conveying hose.

As a result of this, the conveyor pipe line can be easily displaced by means of the slide and at the same time, the suction pipe can be moved inside the container to be emptied across the cross-section of the container/barrel to be emptied due to the very flexible connection hose.

In addition, the conveyor pipe line may preferably comprise a flexible conveying hose having an end, which corresponds to the connector end, attached to the pipe connection. The suspension may be a roll supported by means of a spring suspension, wherein the conveying hose runs and extends, respectively, over the roll and the suspension supports the conveying hose by means of a combination of a rotation of the roll and a spring effect of the spring suspension during the movement of the conveyor end into/out of the container.

Alternatively, the suspension may be a pneumatically driven cylinder at which the conveyor pipe line is attached and which can be pneumatically driven retracted/extended in order to move the conveyor end into/out of the container. Preferably, the conveyor end is formed by a suction pipe which is attached to the pipe connection via a flexible conveying hose. In particular, also in this case, the conveying hose comprises an end, which corresponds to the connector end, attached to the pipe connection, and an other end attached to the pneumatically driven cylinder, wherein the suction pipe is attached to the cylinder and/or the conveying hose via a connection hose which is more flexible than the conveying hose.

Alternatively, the suspension may be a spring balancer which supports the conveyor pipe line during the movement of the conveyor end into/out of the container by means of a spring effect of the spring balancer.

In addition, preferably, the conveyor pipe line comprises a flexible conveying hose having an end, which corresponds to the pipe connection, connected to the pipe connection. Preferably, the suspension is a rocker arm over which the conveying hose runs and extends, respectively, and which supports the conveying hose by means of a tilting movement and a pivoting movement, respectively, during the movement of the conveyor end.

In particular, by means of the suspensions previously described, a weight compensation is achieved, which allows for a very easy handling of the conveyor pipe line and thus for a very easy emptying of the container.

In particular, the suspension is preferably configured so as to return the conveyor end to an initial position, if no force is exerted to the conveyor pipe line by the user, for example by means of the sealingly attached gloves. For example, this can be achieved by a design of the spring effect of the spring suspension which supports the roll or of the spring balancer.

Preferably, the conveyor end is formed by a telescopic suction pipe which can be extended and/or shortened depending on a filling level of the container. Irrespective of whether the telescopic suction pipe forms the complete conveyor pipe line, that means that the conveyor pipe line is extendable starting from the pipe connection, or forms a section of the conveyor pipe line, the overall height of the emptying device according to the invention can be reduced.

Preferably, the conveyor end is formed by a suction pipe or a telescopic suction pipe, wherein the suction pipe or the telescopic suction pipe comprises a gas supply line through which a gas can be guided to an inlet opening at the conveyor end, through which the product enters the conveyor pipe line in intended use.

Preferably, the gas supply line is formed by a gap between an outer pipe of the suction pipe and an inner pipe of the suction pipe, which extends in the outer pipe.

In case of a pneumatic conveying or sucking out of the product to be taken out of the container, a continuous pneumatic conveying can be ensured by means of the supplying of the gas.

Preferably, the emptying device comprises the already explained external connection being in communication with the pipe connection, at which, in intended use, a pneumatic conveyor device is connectible, and the weighing device for a weight determination of the product, wherein the weighing device is arranged such that, in intended use of the emptying device, the insulation device and the container are located on the weighing device.

It is in particular advantageous that the connection of the pneumatic conveyor device is carried out via the stationary (immovable, firmly anchored) external connection. That is, since no suction pipe needs to be guided from the outside through an opening leading into the insulation device and through the internal space into the container, no forces acting from the outside (except for the negligible weight force of an outer hose which extends from the external connection to the pneumatic conveyor device) are exerted on the weighing device and thus falsified weight determinations are prevented. Preferably, the weighing device determines the weight of the product conveyed and taken out, respectively, by generating the difference between the initially measured overall weight and the overall weight measured after taking out of the product.

In addition, the weighing device is preferably arranged and configured such that, in intended use of the emptying device, the user is also located on the weighing device.

As a result of this it is even better prevented that external forces act on the weighing device during the emptying of the container and the taking out of the product, respectively, and lead to a falsified weight determination, because the user itself is located on the weighing device and operations of the user do not result in forces acting on the weighing device.

In addition, an accuracy of the weight determination can be increased by the behavior of the user itself. If, for example, the user pulls the conveyor end of the conveyor pipe line out of the product located in the container and waits until the product located in the conveyor pipe line has been completely sucked out and conveyed, respectively, through the external connection, a very accurate weight determination of the quantity of the product taken out can be determined based on the initially measured overall weight and the overall weight measured after performing the pneumatic conveyance.

Preferably, the insulation device comprises a viewing window through which the user can survey the internal space, wherein the container connection device is obliquely arranged such that, if a container/barrel is connected, an internal space of the container/barrel can be completely viewed by the user through the viewing window and through the internal space.

By this means it is achieved that on the one hand the product located in the container accumulates at an edge in the bottom area of the container and that on the other hand the user can easily see all remnants located in the container.

In addition, the emptying device according to the invention preferably comprises a vibration unit which generates a vibration of the container/barrel. By means of this vibration, remnants of the product to be taken out, which adhere at various positions, are detached and, in particular in the case in which the container is tilted, accumulated at an edge in the bottom area of the container.

Preferably, the insulation device is formed of a metal or plastics. The same applies to the suction pipe of the conveyor pipe line, wherein the suction pipe is generally constructed such that it has a stability necessary for the pneumatic conveyance but that it has an unladen weight as low as possible.

The flexible conveying hose may be formed of plastics having a spiral reinforcement or may also be formed of metal, for example.

In particular, the insulation device is designed such that the user can easily reach all areas of the internal space, in particular the conveyor pipe line, the slide and the suction pipe.

In particular, the emptying device according to the invention is used for emptying of containers/barrels, in which the product is present in the form of a powder or granulate material.

Henceforth, preferred embodiments of the emptying device according to the invention are exemplified with reference to the attached drawings.

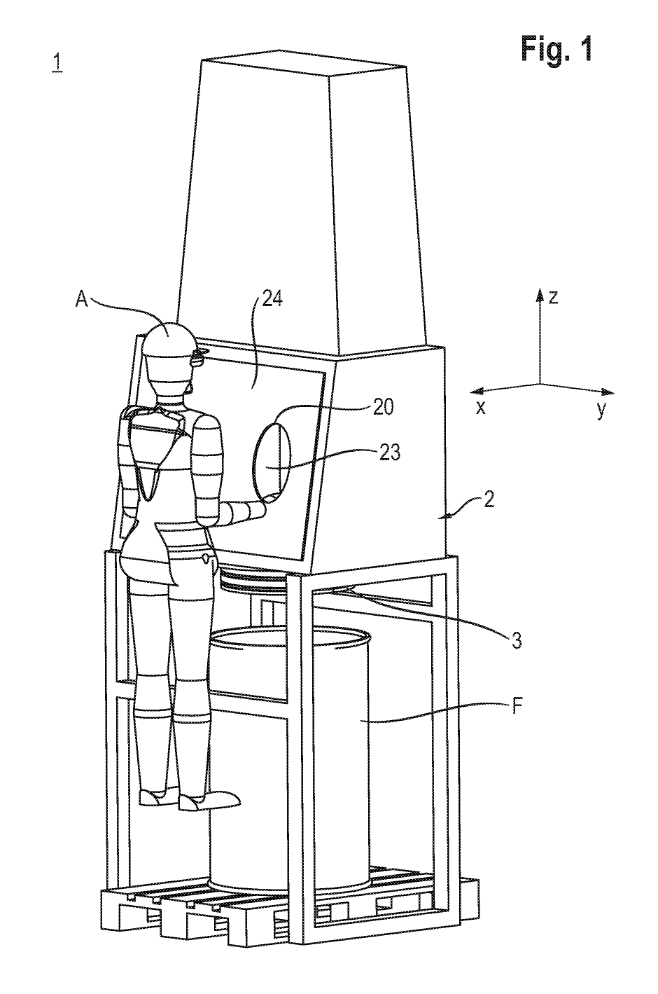

FIG. 1 shows the emptying device according to the invention, wherein a user is located in front of an insulation device having gloves attached thereto, and a barrel to be emptied is arranged below the insulation device and a container connection device.

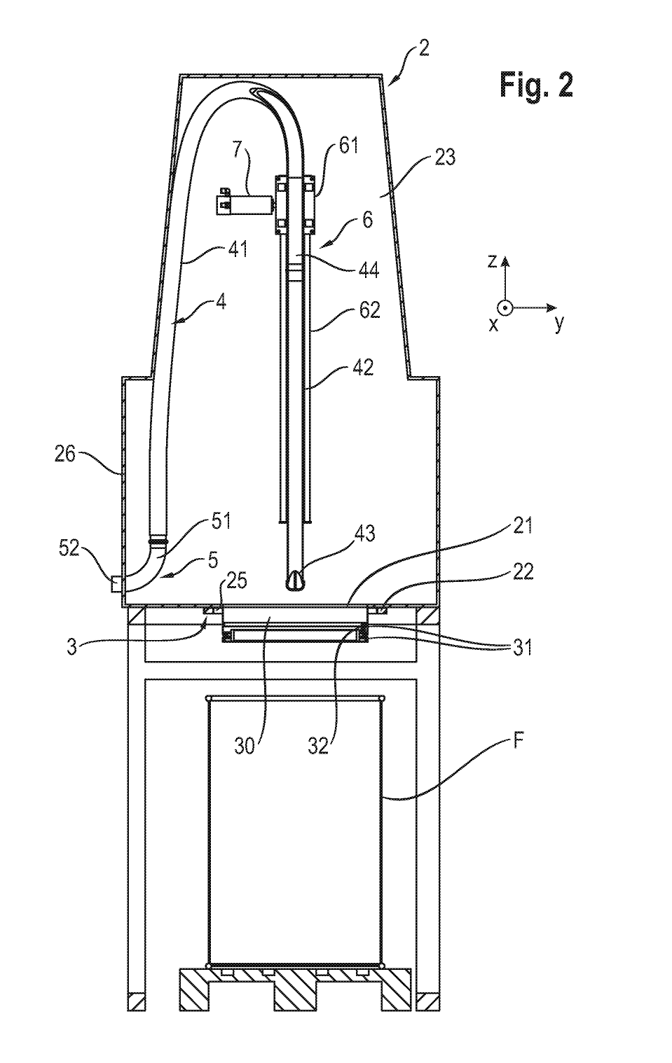

FIG. 2 shows a section of the emptying device according to the invention of FIG. 1, wherein a conveyor pipe line is arranged in its initial position and a corresponding conveyor end is arranged in its starting position.

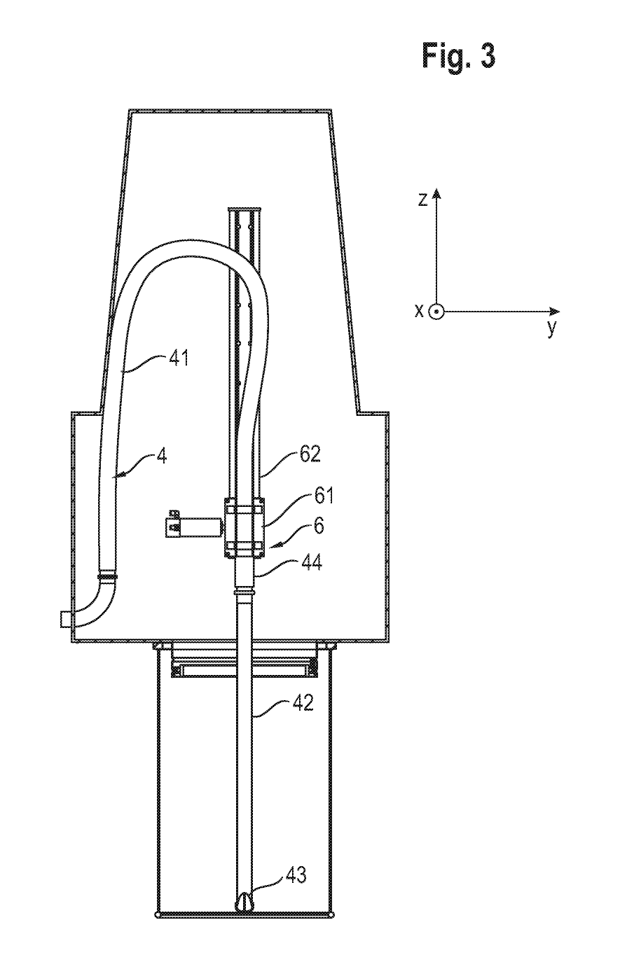

FIG. 3 shows the emptying device according to the invention shown in FIG. 2, wherein the conveyor pipe line and the corresponding conveyor end, respectively, is in a state in which it is maximally displaced into the barrel to be emptied.

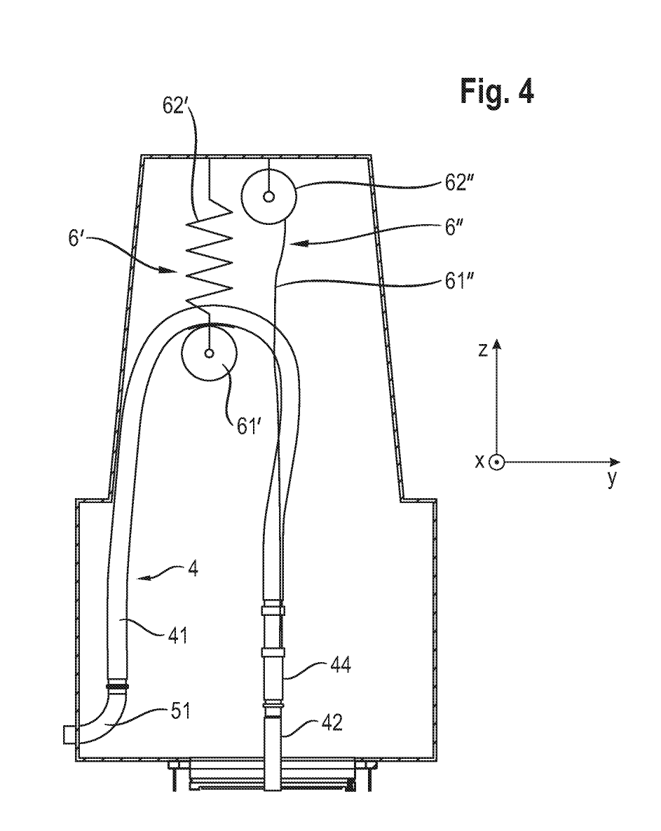

FIG. 4 shows the emptying device according to the invention, wherein two alternative suspensions for the conveyor pipe line are schematically shown.

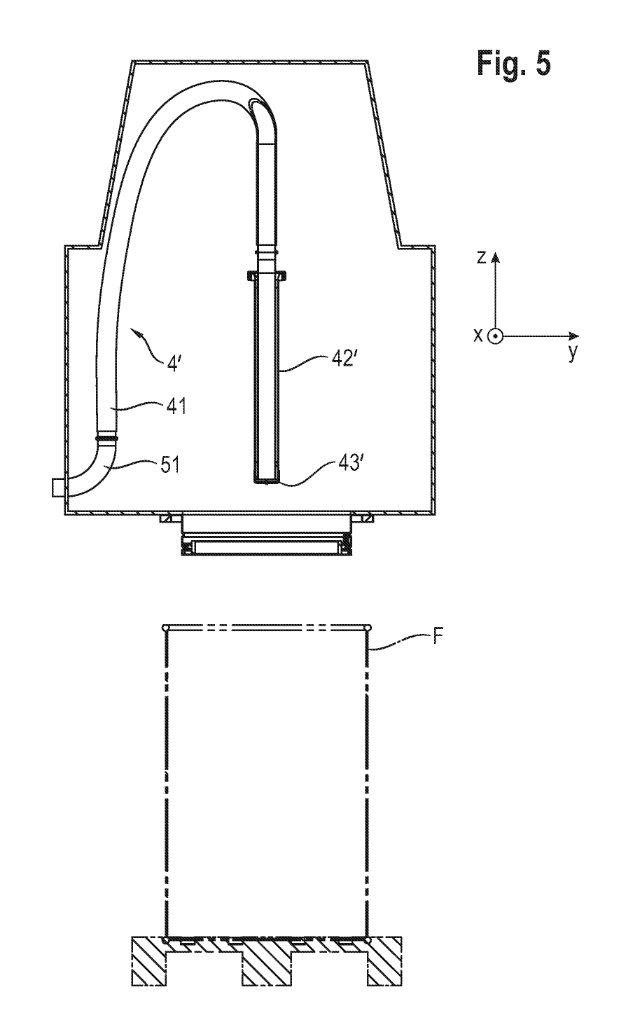

FIG. 5 shows a further variant of a conveyor pipe line arranged in the internal space of the insulation device.

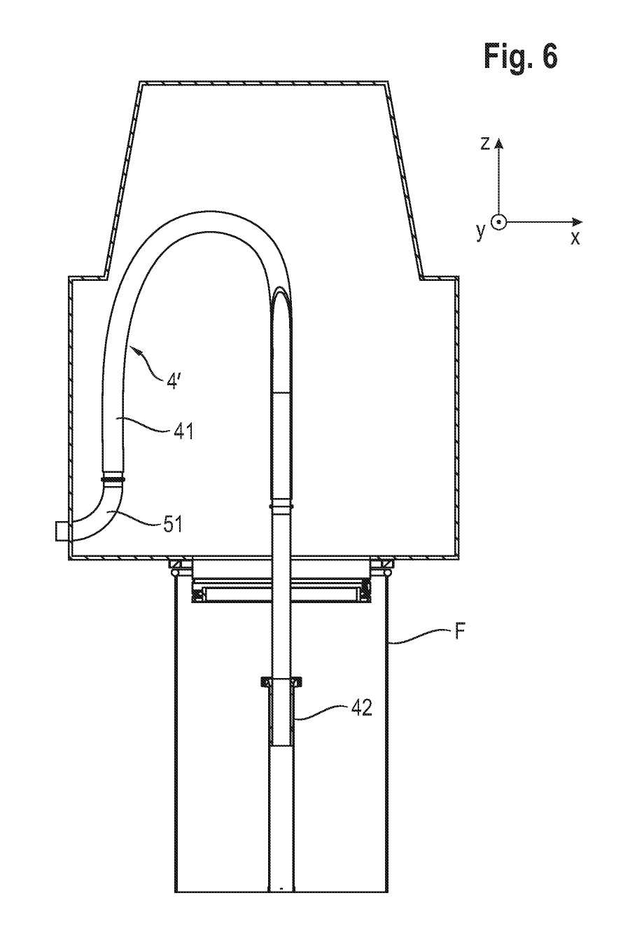

FIG. 6 shows the emptying device according to the invention of FIG. 5, wherein the telescopic suction pipe shown in FIG. 5 is in a state in which it is maximally displaced and moved into the barrel to be emptied.

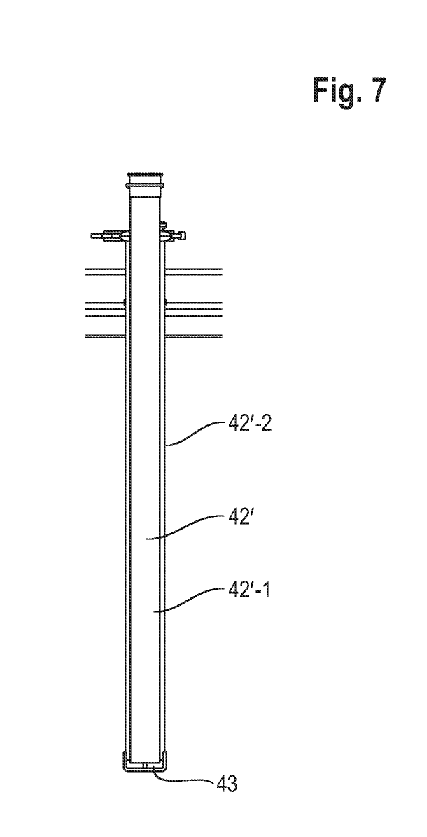

FIG. 7 shows a preferred configuration of a suction pipe which may be applicable with the emptying device according to the invention.

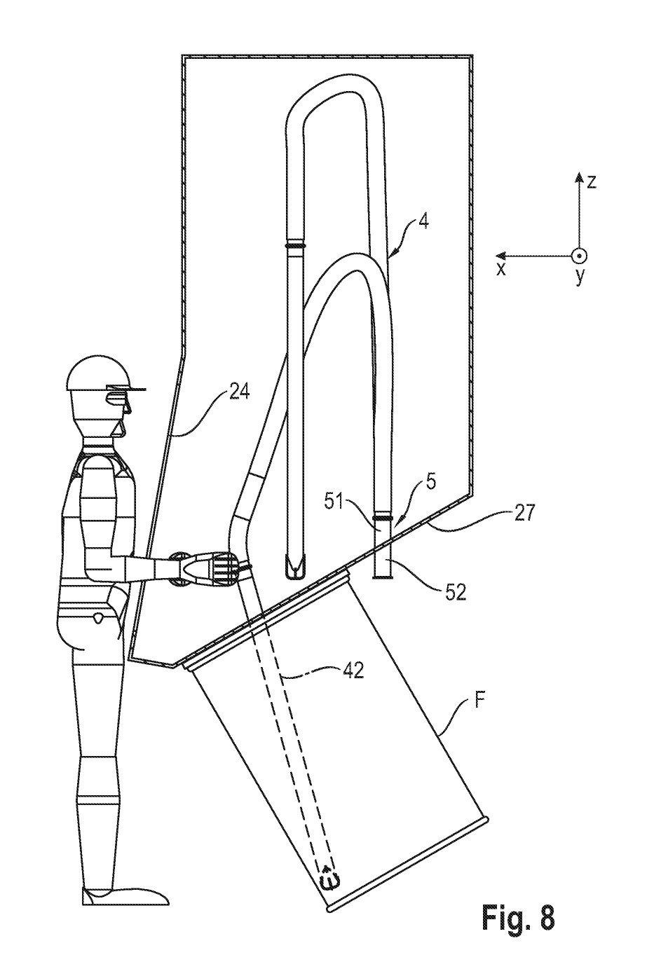

FIG. 8 shows a preferred embodiment of the insulation device of the emptying device according to the invention, wherein one side of the insulation device, at which the container connection device is arranged, runs oblique such that the internal space of the barrel to be emptied is completely visible for a user.

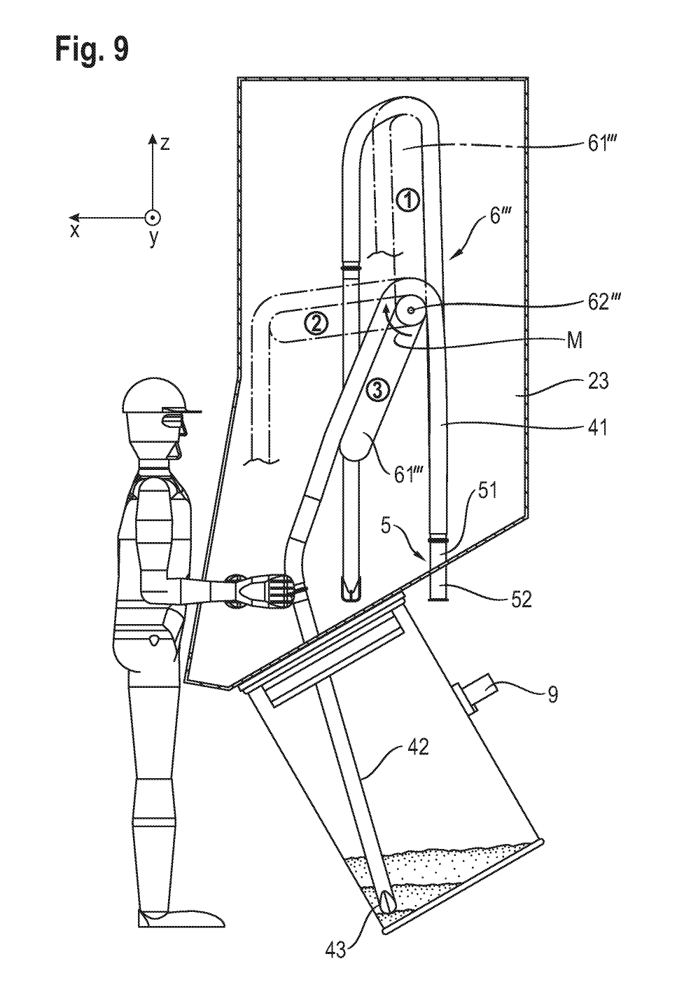

FIG. 9 shows the emptying device according to the invention of FIG. 8, wherein a further preferred alternative suspension of the conveyor pipe line is shown.

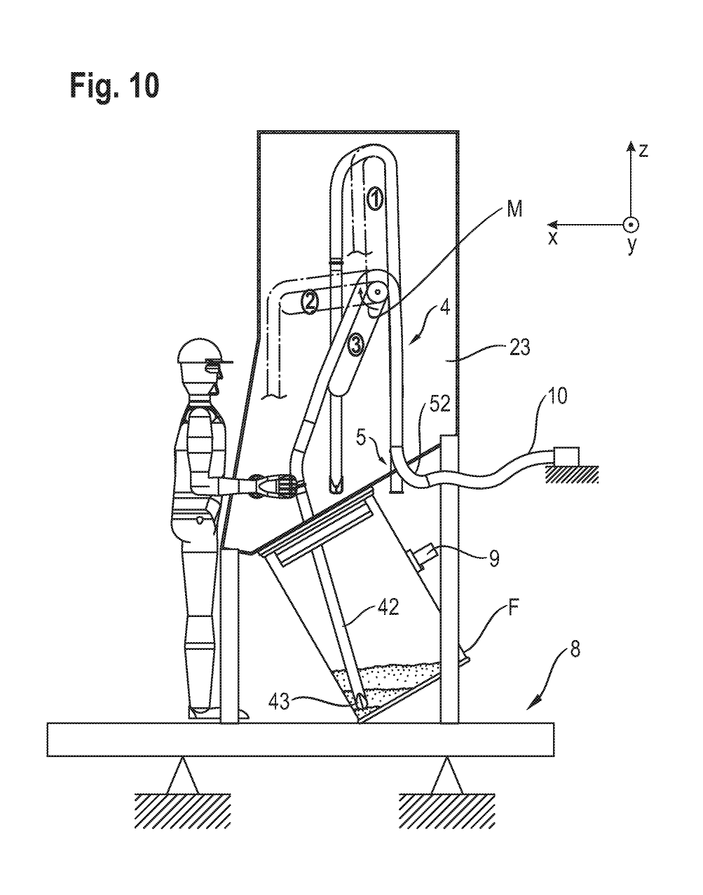

FIG. 10 shows the emptying device according to the invention of FIG. 9, wherein the entire emptying device according to the invention is arranged on a weighing device, together with the user.

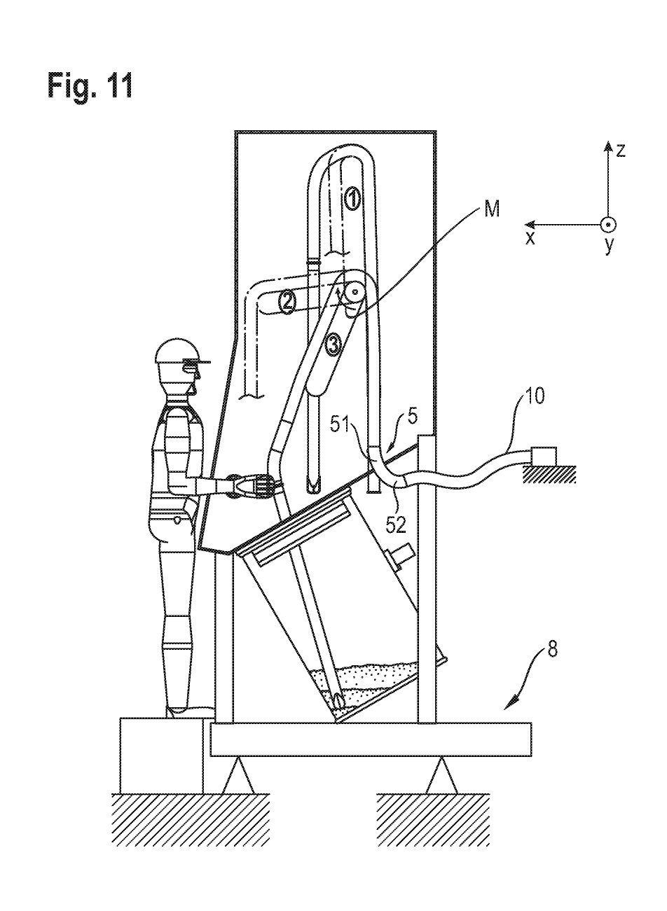

FIG. 11 shows a preferred modification of the weighing device, wherein the weighing device is identical to the one FIG. 9 except for the difference that the user is not present on the weighing device.

In FIG. 1, an emptying device 1 according to the invention is shown, in front of which a user is present and below which a barrel F to be emptied is arranged. The barrel F contains powdery and/or granular materials, which pose a potential risk for the user and the environment upon release. Therefore, it is necessary that this product can be taken out of the barrel F without contamination.

For this purpose, the emptying device 1 according to the invention comprises an insulation device 2 and a container connection device 3 for connecting the barrel F.

The insulation device 2 is preferably formed of an insulator having two openings 20 at which gloves (not shown) are sealingly attached. The user A can insert his/her arms and hands into the gloves through the openings 20 and harmlessly perform operations in an internal space 23 of the insulation device 2 and the insulator, respectively.

Preferably, the insulation device 2 comprises a viewing window 24 so that the user A can watch his/her operations in the internal space.

In the state shown in FIG. 1, the barrel F to be emptied is located below the insulation device 2, so that it can be connected to a container connection device 3 arranged at the bottom side of the insulation device 2.

In case of products which potentially pose a risk, preferably one or two foil bags are provided inside the barrel F, which both enclose the product and each of which are closed separately.

As will be explained in the following, the upper ends of these two foil bags can be attached to the container connection device 3 such that there is no risk for the user by means of the product.

The X-direction shown in FIG. 1 corresponds to the depth direction of the insulation device, the shown Y-direction corresponds to the width direction of the insulation device 2, and the Z-direction corresponds to the height direction of the emptying device 1 according to the invention. The dimensions of the insulation device in the X- and Y-direction are preferably chosen such that the user A can easily reach all components, in particular a conveyor pipe line located in the internal space 23.

As shown in FIG. 1, the container connection device 3 is arranged at a bottom side of the insulator device 2 when seen in the height direction so that the barrel F to be emptied can be brought close to the container connection device 3 and brought to the container connection device 3, respectively, by lifting.

FIG. 2 shows a sectional view of the emptying device 1 according to the invention shown in FIG. 1, wherein the section was performed in the Y-direction at about half of the depth of the insulation device 2. Accordingly, the view shown in FIG. 2 corresponds to the Y-Z-plane and shows the internal space 23 from the point of view of the user A.

The mentioned container connection device 3 is shown at the bottom side of the insulation device 2. The container connection device 3 is formed by a ring 30 which encircles a passage opening 21 leading into the insulation device 2, wherein two recesses 31 are provided at an outer surface of the ring 30, which completely encircle the ring 30. At an inner surface of the ring 30, an inflatable seal 32 is provided, by means of which a clamping ring can be fastened and fixed, respectively.

In the following, connecting of the barrel F will be explained.

In case the barrel F to be emptied is arranged below the insulation device 2, the user, in a first step, opens a lid of the barrel F and attaches an upper end of a foil bag located in the barrel F at the inner recess 31, which faces the bottom side of the insulation device 2, wherein a not shown foil remnant, which is attached to the outer one of the two recesses 31 and originates from a previous emptying operation, is enclosed. The attaching is preferably performed by means of an O-ring. Henceforth, the foil bag attached at the inner one of the recesses 31 can be opened by the user from the outside by removing a corresponding fastener. In case the product, which is located in the barrel F, is enclosed by an additional inner foil bag located in the foil bag, the foil bag attached to the inner one of the two recesses 31 can be opened already before it is attached.

The foil remnant attached to the outer one of the recesses 31 is detached from the container connection device by the user, using the gloves, and disposed inside the insulation device, for example in a waste bag attached to the insulation device 2.

Subsequently, the foil bag attached to the inner one of the recesses 31 is preferably moved to the outer one of the recesses 31.

In this state, by manipulating a lifting device, the barrel F to be emptied is lifted and pressed against a seal 22 located at the bottom side of the insulation device 2.

In case the product located in the barrel F is enclosed by a further closed inner foil bag as mentioned above, the inner foil bag must be opened before the emptying. This is done in that the user puts his/her hands through the openings 20 provided in the insulation device 2 into the gloves and opens, using the gloves, the fastener of the second inner foil bag through the opening 21. The upper end of the inner foil bag is put over the already mentioned clamping ring and fixed by means of an inflatable seal 32 provided at the inner surface of the ring.

Between the ring 30 of the container connection device 3 and the seal 22, also a vacuum connection 25 is provided, through which, in a state in which the barrel F is lifted and pressed against the seal 22, the air between the outer foil bag and the inner wall of the barrel F is sucked out so that the foil bag/the foil bags in the barrel F abut against the inner wall and are not sucked up during the pneumatic conveying/suction of the product which will be explained in the following.

Henceforth, the barrel F is in a state in which it can be emptied. As shown in FIG. 2, a conveyor pipe line 4 is located in the internal space 23 of the insulation device 2, which comprises a flexible conveying hose 41 and a stiff suction pipe 42.

A connection element 5 is provided in a side wall 24 of the insulation device 2, which comprises a pipe connection 51 arranged in the internal space 23 and an external connection 52 arranged at the outer surface of the insulation device 2. For example, the connection element is welded in the side wall 26 of the insulation device 2, in particular such that the pipe connection 51 is located immovably (firmly anchored, stationary) in the internal space 23 of the insulation device 2 and such that the external connection 52 is located immovably (firmly anchored, stationary) at the outer surface of the insulation device 2.

Alternatively, the connection element 5 may be attached to the side wall 26 of the insulation device 2 in a different manner. Examples of this are frictional, firmly bonded and positive-locking attachments, which ensure a tight attachment of the connection element 5 to the side wall 26.

The flexible conveying hose 41 of the conveyor pipe line 4 is attached to the pipe connection 51 located in the internal space 23 and runs in the height direction to an upper area of the insulation device 2, where it runs in an arch and the other end thereof is attached to the suction pipe 42. The suction pipe 42 runs towards the opening 21 and ends shortly before the opening 21. At its lower end in the height direction, the suction pipe has a conveyor end 43 having an inlet opening. In the position shown in FIG. 2, the conveyor pipe line 4 is in its starting position and the conveyor end 43 is in its initial position, respectively.

At the height of the connection between the flexible conveying hose 41 and the suction pipe 42, the conveyor pipe line 4 is attached to a slide 61 of a suspension 6 formed as a guide. The slide 61 engages a guide rail 62 and is displaceable on the guide rail 62. In the height direction, the guide rail 62 runs linearly, whereby the suction pipe 42 of the conveyor pipe line 4 can be lowered in the height direction through the opening 21, and the conveyor end 43 can be brought in contact with the product located in the barrel F.

Due to the flexibility of the conveying hose 41, the conveying hose 41 allows for the movement and the lowering, respectively, of the suction pipe 42 and follows the movement, wherein the end, which corresponds to the pipe connection, of the flexible conveying hose 41 is immovably and stationary attached to the pipe connection 51.

That is, all the moved parts are located in the internal space 23 of the insulation device 2.

In order to support the user's handling of the conveyor pipe line 41, a motor 7 which is electrically or pneumatically driven, for example, is additionally arranged at the slide 61 and can be reached by the user via the gloves in the openings 20 of the insulation device 2. The user may operate the motor 7 for lowering the conveyor pipe line 4 as well as for lifting the conveyor pipe line 4. In other words, the user can displace the slide 61 on the guide rail 62 in both directions (positive Z-direction and negative Z-direction) by means of the motor 7.

At the outer surface of the side wall 26, the already mentioned external connection 52 is provided, at which a not shown pneumatic conveyor device can be mounted, for example via a hose. The pneumatic conveyor device generates, through the external connection 52 and the pipe connection 51, a negative pressure in the conveyor pipe line 4, which results in a gas flow from the internal space 23 through the conveyor pipe line 4 and the connection element 5 towards the pneumatic conveyor device.

In order to compensate a negative pressure forming in the internal space 23, (not shown) filter elements, which allow for a gas flow into the internal space 23, may be provided at the insulation device 2.

Henceforth, in case the motor 7 is operated by a user during the operation of the pneumatic conveyor device such that the slide 61 moves in the negative Z-direction on the guide rail 62, the conveyor end 43 of the suction pipe, which faces the barrel F, approaches the product and comes into contact with the product, respectively. Due to the negative pressure generated by the pneumatic conveyor device, the product located in the barrel F is sucked in and enters the conveyor pipe line 4 through the opening existing at the conveyor end 43. The product streams through the conveyor pipe line 4 to the connection element 5, where it is guided through the pipe connection 51 and the external connection 52 out from the insulation device 2 and enters the hose running to the conveyor device.

Depending on the filling level of the barrel F and the suction power of the pneumatic conveyor device, the user A lowers the suction pipe 42 by operating the motor 7 until the barrel F is emptied. The state, in which the suction pipe 42 and the conveyor end 43, respectively, has reached the bottom of the barrel F and the slide 61 on the guide rail 62 is maximally displaced, respectively, is shown in FIG. 3.

Preferably, the conveying hose 41, in the variant of the conveyor pipe line 4 shown in FIGS. 2 and 3, is indirectly connected via a very flexible connection hose 44 to the suction pipe 42. The connection hose is on the one hand connected to the conveying hose 41 at the slide 61, and on the other hand attached to the suction pipe.

In particular, the flexible connection hose 44 is formed from a material which is more flexible than the conveying hose 41 guided by the suspension 6. In particular, the very flexible connection hose 44 is located between the suction pipe 42 and the slide 61. The very flexible connection hose 44 ensures that the suction pipe 42 can be moved with little effort across the entire cross-section of the barrel (X-Y-plane).

In particular, in this variant of the conveyor pipe line and the suspension 6 thereof, respectively, the motor 7 is only a preferred feature. The slide 61 could also be displaced only manually on the guide rail, or an additional spring device can be provided, which supports the manual displacement of the slide 61 on the guide rail 62

FIG. 4 simultaneously shows to alternative suspensions with respect to the one explained with reference to FIGS. 2 and 3.

As shown in FIG. 4, the conveying hose 41 is again attached on the one hand with one end thereof to the pipe connection 51, and on the other hand attached to the suction pipe 42. The connection hose 41 runs between the pipe connection 51 and the suction pipe 42 over a roll 61′ of a first alternative suspension 6′. The roll 61′ itself is attached at an upper side of the insulation device 2 by means of a spring suspension 62′.

In case the user grasps, by means of the gloves, the conveyor pipe line 4 in order to displace the conveyor end 43 of the suction pipe 42 into the barrel F to be emptied, the roll 61′ rotates in the clockwise direction in FIG. 4, wherein the spring suspension 62′ is simultaneously tensioned. When the user releases the conveyor pipe line 4 after emptying the barrel F, the restoring force of the spring system 62′ causes the suction pipe 42 to be pulled out of the barrel F and to be returned to its initial position. Here, the roll 61′ rotates in the counterclockwise direction. In the variant of the conveyor pipe line shown in FIG. 4, the very flexible connection hose 44 can also be provided at the connection between the suction pipe 42 and the conveyor pipe line 41, which allows that the user holds with one hand the conveyor pipe line 4 at the connection between the conveying hose 41 and the flexible connection hose 44, for example, and moves, with the other hand, the suction pipe 42 across the cross-section of the barrel F for sucking off the product.

FIG. 4 shows a further alternative suspension 6″ for supporting the conveyor pipe line 4 in the internal space 23. The suspensions 6′ and 6″ can be present in the internal space 23 either individually or in combination.

The suspension 6″ is a spring balancer which comprises a wire rope 61″ attached to the conveyor pipe line 4 and which is winded up on a winding roll 62″ or winded down from the winding roll 62″. When the user grasps the conveyor pipe line 4 by means of the gloves, for example, at the connection between the conveying hose 41 and the very flexible connection hose 44, and thereby exerts a force on the conveyor pipe line 4 for lowering the conveyor end 43 of the suction pipe 42, the wire rope 61″ is unwinded from the winding roll 62″, wherein at the same time a restoring force generated by the winding roll 62″ occurs. When the user releases the conveyor pipe line 4 after emptying of the barrel F, the suction pipe 42 is returned to its initial position and the conveyor end 43 is returned to its initial position, respectively.

In particular, the suspensions shown in FIG. 4 provide for weight compensation.

FIG. 5 shows a further variant of a conveyor pipe line 4′ arranged in the insulation device 2, wherein the conveyor pipe line 4′ again comprises a flexible conveying hose 41 having an end attached to the pipe connection 51 and an other end attached to an extendable telescopic suction pipe. Although in this variant of the conveyor pipe line 4 no suspensions are shown, all suspensions previously exemplified can be used here, too.

However, this variant is in particular suitable for a mere manual suction of the product out of the connected barrel F.

Due to its flexible length, the telescopic suction pipe can be very easily handled by a user, which performances operations in the internal space by means of the gloves. Depending on the filling level of the barrel F to be emptied, the user adjusts a specific length of the telescopic suction pipe 42′ and, afterwards, commences to insert the conveyor end 43′ of the telescopic suction pipe 42′ into the connected barrel F and to suck off the product contained therein. The user extends the telescopic suction pipe 42′ according to requirements with decreasing filling level of the barrel F to be emptied, until the telescopic suction pipe 42′ finally reaches a length, which allows for completely emptying of the barrel F. The state, in which the telescopic suction pipe 42′ has a length necessary for completely emptying the barrel F, is shown in FIG. 6. The telescopic suction pipe 42′ may preferably comprise 2, 3 or even more pipe parts for extending the entire telescopic suction pipe 42′.

The telescopic suction pipe 42′ is in particular advantageous in that the height of the insulation device 2 can be reduced in the Z-direction with respect to the insulation device 2 shown in FIGS. 1 to 4.

A preferred variant of a suction pipe 42′ to be connected to the flexible conveying hose 41 is shown in FIG. 7. This suction pipe 42′ comprises an inner pipe 42′-1 and an outer pipe 42′-2, wherein the inner pipe 42′-1 extends through the outer pipe 42′-2. A gap between the outer pipe 42′-2 and the inner pipe 42′-1 acts as a gas supply line, wherein a gas can be guided by means of the gas supply line to the inlet opening at the conveyor end 43 of the suction pipe 42′. The gas exiting the gas supply line at the conveyor end 43 is sucked off, together with the product to be conveyed, into the inner pipe 42′-1 through the inlet opening located at the conveyor end. The supplied gas is in particular advantageous for a continuous conveying.

The suction pipe 42′ shown in FIG. 7 is in particular used in the emptying device 1 according to the invention shown in FIGS. 1 to 4.

FIG. 8 shows the emptying device 1 according to the invention, wherein the insulation device 2 is preferably modified. The bottom side 27 of the insulation device 2 is not formed in a horizontal manner as shown in FIGS. 1 to 7, but runs in the X-Z-plane shown in FIG. 8 oblique such that the barrel F to be emptied can be completely viewed by a user through the window 24 provided the insulation device 2. In other words, the container connection device is arranged such that a barrel F, which is connected to the container connection device in accordance with intended use, is tilted towards the window 24 and the gloves, respectively. This is in particular advantageous in that the product located in the barrel F accumulates at a lower edge of the bottom area of the barrel F, where it can be easily sucked off by a user using the conveyor pipe line 4.

The conveyor pipe line 4 may have one of the configurations exemplified with reference to FIGS. 1 to 7. Only the connection element 5 is configured in the variant of the conveyor pipe line 4 shown in FIG. 8 such that the pipe connection 51 and the external connection 52 together run linearly in the height direction, in contrast to the pipe connection 51 shown in FIGS. 1 to 7, which is bent in the internal space.

FIG. 9 shows the emptying device 1 according to the invention shown in FIG. 8, wherein the conveyor pipe line 4 is supported by a preferred alternative suspension 6′ in the internal space 23 of the insulation device 2. The suspension 6′″ comprises a rocker arm 61′″, which is pivotable around a pivot axis 62′ extending in the Y-direction and width direction, respectively, wherein a restoring moment around the pivot axis 62′ occurs by pivoting the rocker arm 61′″. In the state shown in FIG. 9, the user has almost completely emptied the barrel F. When the user A releases the conveyor pipe line in this state, the restoring moment causes the conveyor pipe line and the conveyor end 43, respectively, to return to its initial position and to be returned to its initial position, respectively.

The pivot axis 62″ of the rocker arm 61′ is located at one end of the rocker arm 61′ and, as already mentioned, the pivot axis 62′ extends in the Y-direction. That is, the rocker arm 61′″ pivots in the X-Z-plane. In the first position of the rocker arm 61′″, the conveyor pipe line 4 and the conveyor end 43 are located in the corresponding initial position. When the user pulls at the conveyor pipe line 4, the rocker arm 61′″ moves into the second position. As can be seen, the leverage of the rocker arm 61′ is raised due to the position of the pivot axis until the second position is reached, whereby in this position the user's necessary effort is lowest. When the user further moves the suction pipe 42 into the barrel F to be emptied, the rocker arm 61′″ changes into the third position.

As shown in FIG. 9, the flexible conveying hose 41 runs and extends, respectively, over the rocker arm 61′″, and is attached on the one hand to the pipe connection 51 and on the other hand to the suction pipe 42. The conveyor pipe line 4 may be configured according to requirements as described with respect to FIGS. 2 to 8.

As can be seen from FIG. 10, a weighing device 8 may be additionally provided, on which the emptying device 1 according to the invention, together with the user, is arranged. As in the previous configurations of the insulation device 2, the connection element 5 is firmly anchored and immovably attached to the insulation device 2.

An outer hose 10 which extends towards the pneumatic conveyor device is attached to the external connection 52 of the connection element 5, wherein it is important to note that the outer hose 10 between the connection element 5 and the pneumatic conveyor device is, in intended use of the emptying device 1, not moved, because the external connection 52 is immovable and stationary. That means, that no forces except for the negligibly weight force of the outer hose 10 itself are transmitted by means of this hose to the emptying device 1 according to the invention, and hence, to the weighing device 8. This force effect can be counteracted by calibrating the weighing device 8 after the connection of the outer hose 10 and before the initial weight determination.

Since the user itself is also located on the weighing device 8 during the emptying, no external forces are transmitted by the user itself to the emptying device 1 and the weighing device 8, respectively, whereby good and reliable weight determinations can be obtained by means of the weighing device 8.

The weight determination may be further improved by the behavior of the user itself. For example, when the user sucks out a certain part of the product located in the barrel F and, thereafter, pulls the conveyor end 43 out of the product, the user A waits until the conveyor pipe line 4 located in the internal space 23 has been emptied so that the weight determination is not falsified by the product in the conveyor pipe line 4. The weight of the product taken out of the barrel F up to this point in time can be easily determined by comparing the initial overall weight with the overall weight now available.

FIG. 11 shows a variant of the weighing device 8 shown in FIG. 10. The only difference is that in the variant shown in FIG. 11, the user is not located on the weighing device 8 but on a platform provided separately for the user. Using this variant, the user should determine the initial weight at a point in time in which the user's arms are not located in the gloves. The purpose of this is that any force effect on the weighing device 8 by the user itself is prevented.

After determining the initial weight, the user grasps the conveyor pipe line in the internal space via the gloves and sucks out a certain amount of the product located in the barrel F. Subsequently, the user transfers the conveyor pipe line 4 into its initial position, in which the conveyor end 43 is not located in the barrel F to be emptied, pulls the arms out of the gloves and determines the current weight of the entire emptying device 1 after the conveyor pipe line 4 has been completely emptied. Again, by comparison with the original/initial overall weight, the weight of the amount of the product taken out can be determined.

As shown in FIGS. 9 and 10, a vibration device 9 may be attached to the barrel F itself, for example, wherein the vibration device 9 oscillates the barrel F so that the product located in the barrel F accumulates at the lower edge of the barrel F.

1-20. (canceled)

21. An emptying device for emptying a container, in particular a barrel, containing a product, the emptying device comprising:
an insulation device which defines an internal space and allows operations of a user in the internal space without a risk of contamination for the user;
a container connection device for connecting the container to the insulation device such that there is no risk of contamination for the user by means of the product; and
a conveyor pipe line arranged in the internal space, the conveyor pipe line having a connector end attached to a pipe connection arranged in the internal space for guiding the product out of the insulation device and being movable for emptying the container such that a conveyor end of the conveyor pipe line is located in the container if the container is connected,
wherein the conveyor pipe line in the internal space is attached to a suspension which allows for the movement of the conveyor end into the container and supports the conveyor pipe line during the movement of the conveyor pipe line;
the suspension comprises a guard rail and a slide which is displaceable on the guard rail; and
the conveyor pipe line is attached to the slide such that the conveyor end is moved either into the container or out of the container by displacing the slide.

22. The emptying device according to claim 21, wherein the conveyor pipe line is formed by a flexible conveying hose and/or a telescopic suction pipe.

23. The emptying device according to claim 21, wherein the conveyor end of the conveyor pipe line is formed by a suction pipe or a telescopic suction pipe, which is attached to the pipe connection via a flexible conveying hose.

24. The emptying device according to claim 21, wherein the guard rail is linear.

25. The emptying device according to claim 21, wherein the conveyor pipe line is movable by means of a motor.

26. The emptying device according to claim 21, wherein a motor is provided at the slide, which can be operated for displacing the slide.

27. The emptying device according to claim 23, wherein the conveyor end is formed by a suction pipe which is attached to the pipe connection via a flexible conveying hose;
the conveying hose having an end corresponding to the connector end attached to the pipe connection and having an other end attached to the slide; and
the suction pipe is attached to the slide via a connection hose which is more flexible than the conveying hose.

28. The emptying device according to claim 21, wherein the suspension is configured so as to return the conveyor end to an initial position, if no force acts on the conveyor pipe line.

29. The emptying device according to claim 21, wherein the conveyor end is formed by a telescopic suction pipe which can be extended or shortened depending on a filling level of the container.

30. The emptying device according to claim 21, wherein the conveyor end is formed by a suction pipe or a telescopic suction pipe, which comprises a gas supply line through which a gas can be guided to an inlet opening of the conveyor end, through which the product enters the conveyor pipe line in intended use.

31. The emptying device according to claim 21, wherein the conveyor end is formed by a suction pipe comprising a gas supply line through which a gas can be guided to an inlet opening of the conveyor end, through which the product enters the conveyor pipe line in intended use, and
the gas supply line is formed by a gap between an outer pipe of the suction pipe and an inner pipe of the suction pipe, which extends inside the outer pipe.

32. The emptying device according to claim 21, wherein the emptying device comprises an external connection which is in communication with the pipe connection and to which, in intended use, a pneumatic conveyor device can be connected, and a weighing device for a weight determination of the product, wherein the weighing device is arranged such that, in intended use of the emptying device, the insulation device and the container are located on the weighing device.

33. The emptying device according to claim 32, wherein the weighing device is arranged such that, in intended use of the emptying device, the user is also located on the weighing device.

34. The emptying device according to claim 21, wherein the insulation device comprises a viewing window through which the user can survey the internal space, and the container connection device is obliquely arranged such that, if a container is connected, an internal space of the container can be completely viewed by the user through the viewing window and the internal space.

35. The emptying device according to claim 21, wherein the emptying device comprises a vibration unit which generates a vibration of the container.
